(19) United States
(12) Patent Application Publication
(10) Pub. No.: US 2026/0147959 A1
(43) Pub. Date: May 28, 2026

(54) MULTI-ENVIRONMENT MODELING AND OPTIMIZATION FOR OPTICAL ASSEMBLIES WITH GENERAL HOUSINGS

(71) Applicant: KEYSIGHT TECHNOLOGIES, INC., Santa Rosa, CA (US)

(72) Inventors: Eric M. Schiesser, Rochester, NY (US); Nicholas Alexander Wakim-Takaki, Fairport, NY (US); Blake G. Crowther, Preston, ID (US); John Rice Rogers, Monrovia, CA (US); Jeffrey M. Hoffman, Birmingham, MI (US); Swetha Suryanarayanan, Pasadena, CA (US); Bryan D. Stone, Westborough, MA (US); Stefan Posea, Pasadena, CA (US); Karen M. Torimaru, Culver City, CA (US)

(21) Appl. No.: 19/402,571

(22) Filed: Nov. 26, 2025

Related U.S. Application Data
(60) Provisional application No. 63/725,758, filed on Nov. 27, 2024.

(51) Int. Cl. G06F 30/20; G06F 111/04; G06F 119/08

(52) U.S. Cl. CPC G06F 30/20; G06F 2111/04; G06F 2119/08

(57) ABSTRACT

Multi-environment modeling and optimization for optical assemblies with general housings, including constructing a computer-based model of an optical assembly, for a first environmental condition, based on a specification of the optical assembly that includes positions of surfaces of optical elements of the optical assembly, dimensions of the optical elements, locations at which the surfaces of the optical elements contact housing elements of the optical assembly, types of materials of the optical elements, and types of materials of the housing elements. The model may be constructed independent of a type of a housing of the housing elements and independent of dimensions of the housing elements. The model may be used to determine distances between surfaces of the optical elements, for the first environmental condition, and to determine the distances for one or more other environmental conditions.

### CROSS-REFERENCE TO RELATED APPLICATION(S)

A claim of priority is made to U.S. provisional application no. 63/725,758, filed Nov. 27, 2025, in the U.S. Patent and Trademark Office, the disclosure of which is incorporated by reference herein in its entirety.

### FIELD

The present disclosure relates to optical systems and, more particularly, to multi-environment modeling and optimization for optical assemblies with general housing.

### BACKGROUND

Whether in the heat of Death Valley, in the cold atop Mount Everest, or as part of a satellite's scientific instrumentation that was assembled on Earth then sent into space, it is important for many optical systems to be able to operate over a wide range of environmental conditions. It has been a long-standing challenge for lens designers to design and model the optical performance of such systems and ensure that such systems will be performant as the optical assembly is subjected to changes in environmental conditions (e.g., temperature, pressure, humidity, and/or gravity). Such systems are referred to as athermalized, and the process of designing them is referred to herein as athermalization. The lowest-order effect seen in non-athermalized systems is typically that the best-performing location of the detector changes with temperature, but other aberrations can also be introduced.

### SUMMARY

According to an aspect of the inventive concepts, a computer-implemented method for modeling an optical assembly across multiple environmental conditions is provided. The method includes retrieving a specification in electronic format of an optical assembly for one or more environmental conditions among the multiple environmental conditions, the specification being devoid of at least some optical system information of the optical assembly for at least one of the multiple environmental conditions. The method further includes constructing a computer model of the optical assembly based on the specification, the computer model operative for the multiple environmental conditions, wherein the computer model computes the optical system information for the multiple environmental conditions from the specification.

Constructing the computer model may include computer modelling surfaces of optical elements of the optical assembly as respective nodes of a first graph and, for each node of the first graph, representing a distance between the corresponding surface and a reference surface as a distance type edge between the corresponding nodes of the first graph. Constructing the computer model may further include computer modelling the surfaces of the optical elements as nodes of a second graphical representation and, for each distance type edge of the first graph that connects nodes corresponding to first and second surfaces of an optical element, connecting the corresponding nodes of the second graph with a solidity type edge. Constructing the computer model may still further include computer modelling the surfaces of the optical elements as nodes of a third graph and, for each housing element that contacts surfaces of two or more of the optical elements, connecting the corresponding nodes of the third graph with a housing type edge that indicates the type of material of the housing element.

According to another aspect of the inventive concepts, a computer-implemented method for modeling an optical assembly across multiple environmental conditions is provided. The method includes retrieving a specification in electronic format of the optical assembly, constructing a first graph in which surfaces of optical elements are represented as nodes and distances between the surfaces as distance type edges based on the specification of the optical assembly, constructing a second graph in which the surfaces are represented as nodes and materials between consecutive surfaces are represented as solidity type edges or fluidity type edges, constructing a third graph in which the surfaces are represented as nodes and housing elements that contact surfaces of multiple optical elements are represented as housing type edges indicating material types of the housing elements, determining lengths of the housing elements for a nominal environmental condition based on paths between nodes in the first graph and the housing type edges in the third graph, and determining positions of the optical elements for one or more additional environmental conditions based on the determined lengths and material properties of the housing elements.

According to still another aspect of the inventive concepts, a non-transitory computer-readable medium storing instructions that, when executed by a processor, cause the processor to perform operations. The operations include modeling an optical assembly for multiple environmental conditions by constructing multiple graph representations of the optical assembly, wherein the graph representations include a distance graph representing coordinate system relationships between optical element surfaces, a solidity graph representing material properties between surfaces, and a housing graph representing housing element connections between non-adjacent optical elements. The operations further include computing housing element dimensions from an optical assembly specification without requiring explicit housing dimensions in the specification, and automatically determining optical element positions for varying environmental conditions based on the computed housing element dimensions and thermal expansion properties of housing materials.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 depicts an optical assembly and a corresponding sequential lens specification, according to an embodiment.

FIG. 2 depicts an optical assembly (i.e., a triplet), according to an embodiment.

FIG. 3 depicts an optical system that includes optical elements, a cylindrical housing element, and spacers, according to an embodiment.

FIG. 4 depicts multiple overlaid instances of the optical system of FIG. 3, each corresponding to a respective environmental condition, according to an embodiment.

FIG. 5A depicts an optical system that includes a triplet-based optical assembly 502 and a simple seat-based housing, according to an embodiment.

FIG. 5B depicts an optical system that includes a triplet-based optical assembly 552 and a simple seat-based housing, according to another embodiment.

FIG. 6 depicts the optical system of FIG. 5, overlaid with dotted lines corresponding to mechanical fiducial surfaces that are added to facilitate the calculation of thermal expansion, according to an embodiment.

FIG. 7 depicts an optical system, according to an embodiment.

FIG. 8A depicts the optical system of FIG. 7, according to an embodiment.

FIG. 8B depicts a region of the optical system of FIG. 8A, according to an embodiment.

FIG. 9 depicts another optical system, according to an embodiment.

FIG. 10 depicts another optical system, according to an embodiment.

FIG. 11 depicts an optical element, according to an embodiment.

FIG. 12 depicts another optical system, according to an embodiment.

FIG. 13 depicts another optical system that includes an optical assembly and housing elements, according to an embodiment.

FIG. 14 depicts a modeling system that models optical assemblies, according to an embodiment.

FIG. 15 depicts a method of constructing a model of an optical assembly and using the model to determine parameters of the optical assembly under one or more environmental conditions, according to an embodiment.

FIG. 16 depicts a first graph (i.e., a distance or coordinate system graph), according to an embodiment.

FIG. 17 depicts a second graph (i.e., a solidity graph), according to an embodiment.

FIG. 18 depicts a third graph (i.e., a housing graph), according to an embodiment.

FIG. 19 depicts a graph for determining lengths of housing elements, according to an embodiment.

FIG. 20 depicts an initial composite graph that includes sub-graphs formed by solidity type edges of the graph of FIG. 17, according to an embodiment.

FIG. 21 depicts the composite graph with a housing edge of the third graph that connects sub-graphs of the composite graph, according to an embodiment.

FIG. 22 depicts the composite graph with another housing edge of the third graph that connects sub-graphs of the composite graph, according to an embodiment.

FIG. 23 depicts the composite graph with a distance type edge of the first graph, according to an embodiment.

FIG. 24 depicts a subgraph of the composite graph, according to an embodiment.

FIG. 25 depicts another subgraph of the composite graph, according to an embodiment.

FIG. 26 depicts a subgraph of the composite graph, according to an embodiment.

FIG. 27 depicts another subgraph of the composite graph, according to an embodiment.

FIG. 28 depicts a subgraph of the composite graph, according to an embodiment.

FIG. 29 depicts another subgraph of the composite graph, according to an embodiment.

FIG. 30 depicts a composite graph for an example in which an optical assembly is specified using a coordinate system of FIG. 2, according to an embodiment.

FIG. 31 depicts a diagram of an example computer system in which embodiments of the present disclosure may operate.

### DETAILED DESCRIPTION

Aspects of the present disclosure relate to multi-environment modeling and optimization for optical assemblies with general housings.

An optical system may include an optical assembly having optical elements mounted within a housing. The term “optical elements,” as used herein, refers to components within an optical path of an optical system such as, without limitation, lenses, mirrors, roof prisms, corner cubes, apertures, an object surface, or an image surface (e.g., a detector plane).

The term “housing elements,” as used herein, refers to mechanical components of a housing that retain optical elements in desired positions/locations within the housing, such as seats, spacers, and/or subassembly cells. The housing may be rotationally symmetric or non-rotationally symmetric.

Changes in environmental conditions may result in physical changes to elements of an optical system, such as changes in physical dimensions (e.g., enlargement and/or contraction) of optical elements and/or housing elements, which may impact alignment of the optical components, focal distances, and/or other parameters of the optical system. Environmental conditions that impact housing elements may include, for example and without limitation, temperature, pressure (e.g., barometric pressure), humidity, and/or gravity (e.g., for extraterrestrial applications).

An optical assembly can be described or defined in a specification (e.g., based on a standardized format or protocol). The specification may be used for modeling/evaluating a design of the optical system (e.g., for achieving suitable optical performance in the design). The specification may, for example, be provided to a modeling system to model the optical system under different and/or varying environmental conditions.

A modeling system may be designed for a particular type of housing (e.g., spacer-based housings or relatively simple seat-based housings). An athermalization tool designed for a particular type of housing may reduce the complexity of input data, but may not be suitable for other types of housings without significant modification. More complex optical systems may include complex seat-based housings or a combination of spacer-based and seat-based housings. The more complex optical systems may necessitate specialized/dedicated modeling systems.

Some methods for modeling optical assemblies do not accommodate general housings (i.e., various types of housings), without substantially modifying a specification, substantially modifying an optimization approach via constraints, substantially restricting the housing (e.g., to a spacer-based or simple seat-based housing), or combinations thereof. Modeling systems and methods disclosed herein overcome the aforementioned technical challenges.

Modeling systems and methods disclosed herein are not limited to specific housing types. Rather, modeling systems and methods disclosed herein can model general housings (i.e., multiple types of housings and housings of varying complexities), without modification of a specification and without specialized user-expertise. For example, modeling systems and methods disclosed herein do not require adjacent optical elements to be held by the same housing structure, and support simple seat-based housing structures, spacer-based housings, and more-complicated housing structures. Support for general housings permits users to easily explore a variety of housing strategies for athermalizing an optical assembly.

With modeling systems and methods disclosed herein, an optical assembly may be specified for a desired nominal environmental condition using optical component parameters (e.g., dimensions of optical components, relative positions of the optical components, and locations at which the optical components contact housing elements, without dimensions of the housing elements). Based on the types of materials of the housing elements contacted by optical elements, the modeling tool determines nominal lengths/distances between the points of contact, and determines environmentally-induced changes in the nominal lengths/distances and/or other parameters based on materials of the housing elements between the points of contact. In other words, the modeling system essentially infers information regarding housing elements, without needing dimensions of the housing elements. An optical assembly may be specified for a nominal environmental condition, and the specification may be used as a starting point for athermalization without reworking the original design. The modeling system may use the same optimization method for multiple environmental conditions.

Based on an initial specification of an optical assembly for a nominal environmental condition, modeling systems and methods disclosed may generate a dependent specification for each of one or more other environmental conditions.

Additional technical advantages are described below. The listing of technical advantages is not exhaustive.

Modeling systems and methods disclosed herein may be employed without modification of existing optimization procedures. A modeling system disclosed herein may use the same method(s) for modeling an optical assembly under multiple environmental conditions and/or for different types of housings.

Modeling systems and methods disclosed herein may model an optical assembly under multiple environmental conditions, in parallel,

Modeling systems and methods disclosed herein may accommodate proposed/contemplated design changes/optimizations made to a specification (e.g., by an optimization tool). In an example, if a change/optimization is made to a specification, the modeling systems automatically model the optical system under multiple environmental conditions (e.g., in parallel).

Modeling systems and methods disclosed herein accommodate dynamic or real-time changes to a specification during modeling (e.g., as part of an optimization procedure), and may thus readily integrate with existing and/or future-developed optimization tools. A modeling system disclosed herein may automatically apply modifications to a specification even for complicated housing structures.

Modeling systems and methods disclosed herein may simultaneously model an optical assembly for multiple environmental conditions.

Modeling systems and methods disclosed herein may automatically detect over-determined or under-determined housings, including interactions with existing constraints on system geometry, such as aspect ratio of optical elements, maximum and/or minimum center thickness of optical elements, etc., as well as constraints on imaging properties such as, without limitation, paraxial image location and focal length.

Modeling systems and methods disclosed herein may efficiently order computations of intermediate values that are used in multiple calculations.

Some examples herein are provided with respect to refractive singlet based optical assemblies. Unless indicated otherwise herein, the examples apply to other types of optical assemblies such as, without limitation, cemented doublets, cemented triplets, reflective mirrors, Mangin mirrors, and diffractive surfaces. For example, while the thermal expansion of refractive singlets in terms of the coefficient of thermal expansion (CTE) of the glass of the singlet is a trivial isometric scaling, systems and methods disclosed may be applied to determine the expansion of cemented elements, which would depend on the CTEs of the optical elements, the material properties of the cement, stress on the optical elements, and/or other factors.

Systems and methods disclosed herein may model optical properties of an optical system based on ray traces through surfaces of the optical assembly (e.g., in a sequential order or out-of-order). This approach is familiar to designers. It also has computational advantages, including the ability to determine an intersection of a ray with only the next surface in sequential order rather than having to consider all the surfaces in an optical assembly. For this reason, locations of a surface of an optical element may be specified in terms of displacement along a shared or common axis with respect to a preceding surface. Systems and methods disclosed here may be applied to models in which the ray traces encounter surfaces in an sequence defined by a specification and/or in a sequence other than defined in the specification. Systems and methods disclosed here may be applied to optical assemblies in which optical elements share a common axis and/or to optical assemblies in which optical elements do not share a common axis.

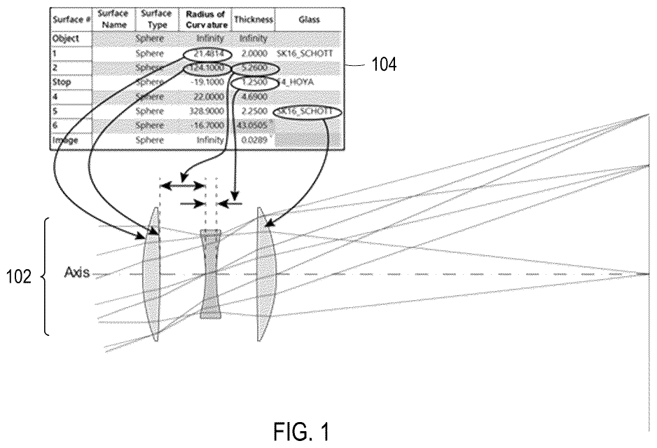

FIG. 1 depicts an optical assembly 102 and a corresponding sequential lens specification 104, according to an embodiment. In the example of FIG. 1, optical assembly 102 is depicted as a triplet, and specification 104 includes a table of lens data (e.g., generated using an optical design tool) describing the triplet. A triplet optical assembly is a lens system having three single lens that work together to guide light and create an image. Circled data with arrows are examples of how the data in the table corresponds with the triplet. The radii of curvature for surfaces 1 and 2 correspond to the radii of curvature of the first element. The first circled thickness corresponds to the distance between a vertex of a rear surface of a first lens and a vertex of a front surface of a second lens. The third circled thickness in the table corresponds to a distance between the vertices of the front and rear surfaces of the second lens. The third glass in the table is the material of the third lens. In the example of FIG. 1, the first circled thickness entry specifies that the vertex of the front surface of the second lens is located 5.26 mm after the vertex of the rear surface of the first lens. Similarly, the second circled thickness entry describes the thickness of the second optical element by specifying that the vertex of its rear surface is 1.25 mm after the vertex of its front surface.

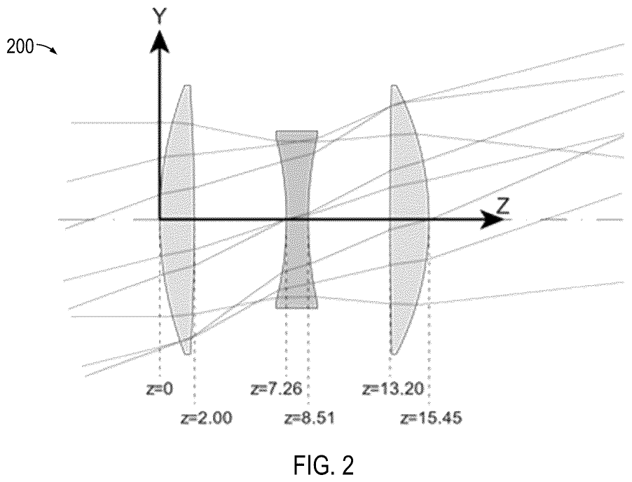

In another example, surface locations may be specified with respect to a global coordinate system, such as described below with reference to FIG. 2. FIG. 2 depicts an optical assembly 200 (i.e., a triplet), according to an embodiment. In the example of FIG. 2, optical assembly 200 is depicted with reference to a global coordinate system. For each surface of each optical element of optical assembly 200, a dashed line depicts a plane tangent to the vertex of the surface. The location of each surface is then specified via the z distance from the tangent plane of the surface to the tangent plane of the first surface. In this sense, the location of each surface is referenced to the first surface. In the example of FIG. 2, the location of each surface is specified in terms of the z distance from the vertex of the surface to the vertex of the first surface. Because the coordinate system of the first surface does not depend on the other surfaces in the system, it is a global coordinate system.

In another example, a lens designer may generate a computer-aided design (CAD) based model of an optical assembly. Methods disclosed herein may be applied to any or all of foregoing methods of specifying positions of optical elements of an optical assembly.

In examples above, positions of optical elements assemblies are specified relative to one or more reference points or surfaces, independent of housing elements. As described below, methods disclosed herein may be useful to model an optical assembly (e.g., for various environmental conditions), based on a specification of the optical assembly and properties of materials of the housing elements that contact optical elements of the optical assembly, independent of (i.e., without reference to) dimensions of the housing elements. Methods disclosed herein may thus be useful to model an optical assembly (e.g., for various environmental conditions) for a variety of types of housings, examples of which are provided below.

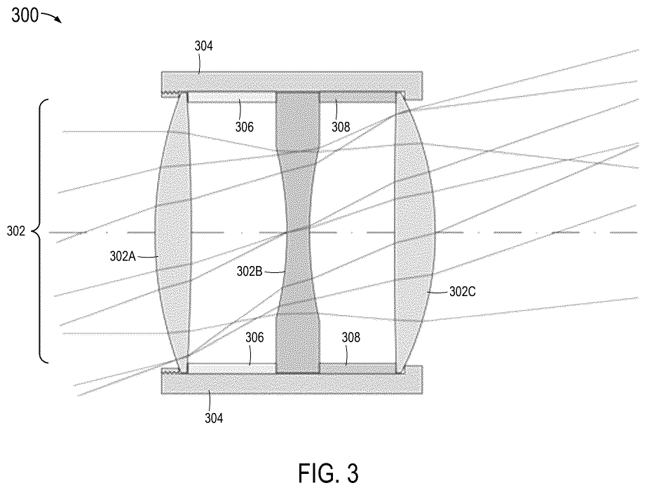

Spacer-based housings are described below. A spacer-based housing includes a cylindrical tube with spacers to maintain desired spacings between optical elements, such as described below with reference to FIG. 3. FIG. 3 depicts an optical system 300, according to an embodiment. In the example of FIG. 3, optical system 300 includes optical elements 302A, 302B, and 302C (collectively, optical elements 302), a cylindrical housing element 304, and spacers 306 and 308. Spacers 306 and 308 may be made of the same material or different material. Lengths of spacers 306 and 308 determine distances between adjacent optical elements. Cylindrical housing element 304 retains optical elements 302 against spacers 306 and 308. As described below, environmental conditions may impact positions of the optical elements.

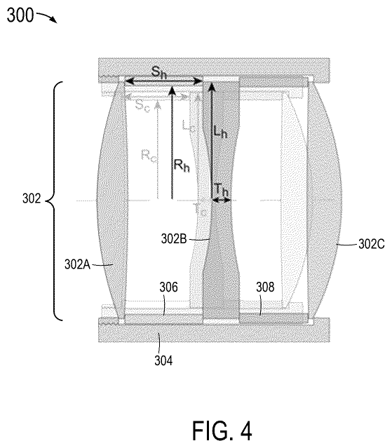

FIG. 4 depicts multiple overlaid instances of optical system 300, each corresponding to a respective environmental condition, according to an embodiment. In the depiction of FIG. 4, environmental impacts are exaggerated for illustrative purposes. As described below, shapes, positions, and optical properties of optical elements 302, and housing lengths depend on environmental conditions. As environmental conditions (e.g., temperature) change, impacts on optical elements 302 and spacers 306 and 308 may depend on a variety of factors that include:
The refractive indices of optical elements 302 may change as a function of wavelength and environmental conditions.
Dimensions (e.g., sizes and/or shapes) of optical elements 302 may change based on environmental conditions and properties (e.g., CTE) of materials of optical elements 302. In FIG. 4, a lens semi-aperture for optical element 302B changes from Lc to Lh as optical element 302B is heated. Likewise, a thickness of optical element 302B changes from Tc to Th. Where optical element 302B is heated uniformly, there are no temperature gradients across optical element 302B, such that Lc/Lh=Tc/Th. Dimensions of spacers 306 and 308 may also change based on the CTE of the respective spacer. A length of spacer 306 changes from Sc to Sh, and a semi-diameter of spacer 306 changes from Rc to Rh. Where spacer 306 is heated uniformly, there are no temperature gradients along spacer 306, so that Sc/Sh=Rc/Rh.
Spacers 306 and 308 may expand at different rates than optical elements 302 (e.g., glass), so the points where the spacers contact the optical elements may change with environmental conditions. The changes may affect the relative positions of the optical elements. This may be mitigated somewhat, such as by designing the spacers to contact the optical elements on flat interfaces, as illustrated in FIG. 4 with respect to optical element 302B.

A modeling system designed specifically for an optical system having a spacer-based housing may permit a user to omit lengths of the spacers from a specification of the optical system. Instead, the modeling system may determine the lengths based on the semi-diameters at which the spacers contact the optical elements, and the positions of the optical elements. Such a system may provide a convenient way to specify the spacers, but may not be useful for other types of housings (e.g., seat-based housings).

An example method of modeling an optical system having a spacer-based housing is described below. The method may be performed by a modeling system designed specifically for an optical system having a spacer-based housing.
1. Lengths of spacers are determined for a first (e.g., nominal) environmental condition (e.g., a first temperature) based on a specification of the optical system, such as described above with reference to FIG. 1 and/or FIG. 2.
2. Dimensions of optical elements of the optical system are scaled based on material properties of the respective optical elements (i.e., for glass singlets, the CTE of the glass) and a second environmental condition (e.g., a second temperature).
3. The dimensions of the spacers are scaled according to the CTEs of materials of the spacers.
4. Locations at which the spacers contact the optical elements are determined for the second environmental condition. The locations depend on the CTEs of the optical elements, the CTEs of the spacers, and surface profiles of the optical elements.
5. Values of a surface function are determined for the scaled surfaces determined at 2 above, for each of the locations determined at 4 above.
6. Center thicknesses between the optical elements are determined from the values determined at 406 and 410.

An approach similar to the method above may be used to model locations/positions of optical elements in global coordinates.

With the method above, the positions of optical elements of an optical assembly may be determined for one or more of a variety of environmental condition(s), and results may be provided in the same manner/format as the original specification of the optical system. As an example, if the original specification specifies vertex-to-vertex thicknesses, the method may provide vertex-to-vertex thicknesses at various environmental conditions. In another example, similarly, if the original specification specifies the optical assembly based on a global coordinate system or based on a CAD model, the method may provide results in the global coordinate system or in a CAD format.

An optical assembly may be modeled for a variety of different temperatures as described above, and may be analyzed to determine how the optical assembly will perform over the given range of temperatures. Similarly, the specification of the optical assembly and the housing may be optimized to improve the optical performance of the system over the range of temperatures.

Where the foregoing method is performed by a modeling system designed specifically for an optical system having a spacer-based housing, the modeling system will determine the distance between two optical elements, for a given environmental condition, based solely on material properties of the spacer separating the two optical elements, materials of the optical elements, and shapes of surfaces of the optical elements contacted by the spacer. In other words, a modeling system designed specifically for an optical system having a spacer-based housing cannot accommodate an optical element that is retained in place with any means other than a spacer.

Seat-based housings are described below. In a seat-based housing, housing elements have seats at which optical elements contact the housing, and mechanical housing elements may be specified relative to seats of adjacent optical elements to simplify modeling of the systems in optical design software.

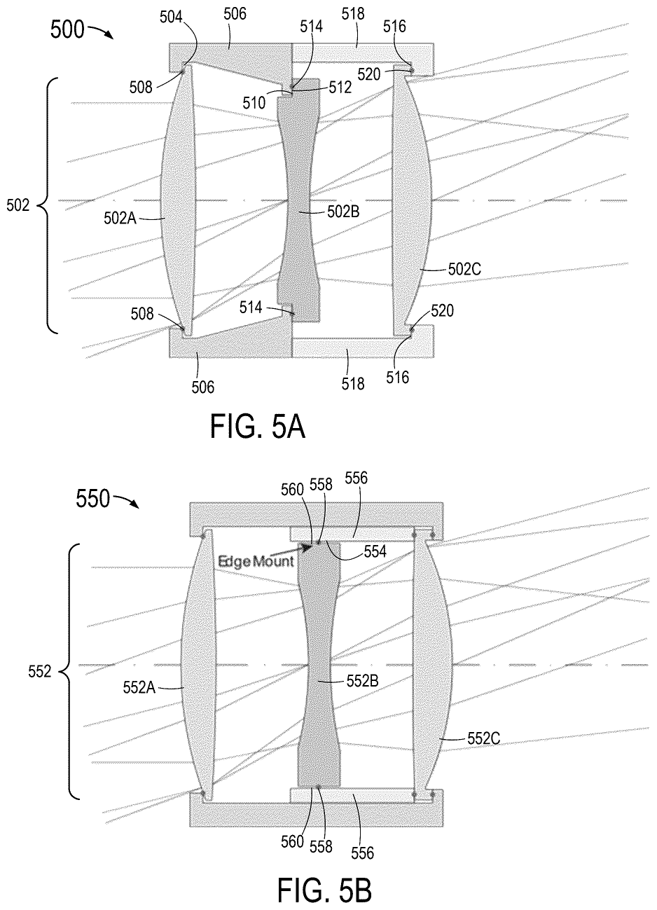

FIG. 5A depicts an optical system 500 that includes a triplet-based optical assembly 502 and a seat-based housing, according to an embodiment. Optical assembly 502 includes optical elements 502A, 502B, and 502C.

An outer edge or rim of optical element 502A is positioned within an annular seat 504 of a housing element 506, such that optical element 502A contacts housing element 506 along an annular ring, depicted here as points 508.

A recessed portion 510 of optical element 502B is dimensioned to receive an annular seat 512 of housing element 506, such that optical element 502B contacts housing element 506 along an annular ring, depicted here as a points 514.

An outer edge of optical element 502C is positioned within an annular seat 516 of a housing element 518, such that optical element 502C contacts housing element 518 along an annular ring, depicted here as at points 520.

In the example of FIG. 5A, housing element 506 ends exactly at a location where housing element 518 begins.

FIG. 5B depicts an optical system 550 that includes a triplet-based optical assembly 552 and a seat-based housing, according to another embodiment. Optical assembly 552 includes optical elements 552A, 552B, and 552C. In the example of FIG. 5B, a flat edge 56 of optical element 502D is positioned against (e.g., adhered to) a flat surface seat 554 of a housing element 556, such that optical element 502D contacts housing element 506 along an annular ring, depicted here as points 558. Optical element 502D may be referred to as an edge mounted optical element.

Some features of relatively low-complexity seat-based housings are listed below.

In a relatively low complexity seat-based housing, each optical element may contact a housing element on one surface (i.e., the seat).

In a relatively low-complexity seat-based housing, optical elements generally remain in contact with the respective housing via mechanical forces and/or an adhesive. If an adhesive is used for potting, the adhesive is generally flexible enough to allow for differential expansion of the optical element and the housing element without introducing significant stress or strain to the optical element. Mechanical retention may include a retaining ring and/or a spring-like mechanism.

In a relatively low-complexity seat-based housing, optical elements may contact the respective housing elements on a curved surface (e.g., optical element 502A), on a flat surface that is cut into the optical element (e.g., optical element 502B), on a flat surface that extends from the lens (e.g., optical element 502C), or on a flat edge (e.g., optical element 552B in FIG. 5B).

A relatively low-complexity seat-based housing may include multiple housing elements, which may be made of the same material (i.e., a monolithic housing), or may be made of different materials.

In a relatively low-complexity seat-based housing may, seats of neighboring elements may contact the same housing material, and lengths/distances between seats of adjacent optical elements may be determined based on the material of the housing element.

For an optical system having a relatively low-complexity seat-based housing, a length/distance between seats of a housing element may be determined for a nominal environmental condition based on a specification of the optical assembly and locations at which the housing seats contact the respective optical elements. The length/distance for the nominal environmental condition may serve as a basis for determining how the optical elements move with respect to one another other under other environmental conditions.

A modeling system designed specifically for optical systems having relatively low-complexity seat-based housings may permit or require a user to specify surfaces/seats, computations (e.g., linked parameter data or pickups), and optimization constraints. Such a system may provide a convenient way to specify the surfaces/seats, the user-defined computations, and optimization constraints, but may not be useful for other types of housings (e.g., spacer-based housings). Such a system may require users to indicate which surface of each optical element is seated against the housing, where each seat is located relative to the surface vertex, and the CTE of the housing material that connects each seat to the next seat. When such a system is run or executed, additional mechanical fiducial surfaces and user-defined computations are added to the model to perform the environmental changes, and user-defined optimization constraints are required to ensure these calculations and additional surfaces continue to enforce the correct environmental changes as the parameters of the nominal design are modified through optimization. Note that changes to the nominal design that are not from optimization (e.g., manually changing a lens radius of curvature) will not properly update the lens parameters for the non-nominal temperatures.

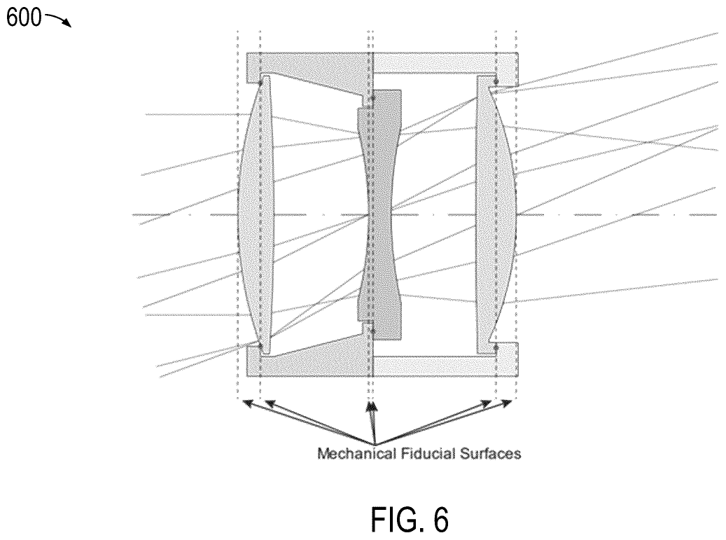

FIG. 6 depicts optical system 600, overlaid with dotted lines corresponding to mechanical fiducial surfaces that are added to facilitate the calculation of thermal expansion, according to an embodiment. In this example, nine mechanical fiducial surfaces are added to the design (noting that two overlapping mechanical fiducial surfaces are added at each seat location), which more than doubles the number of surfaces from the nominal. These additional surfaces, user-defined calculations, and optimization constraints can substantially change the way in which the nominal design is specified, even though the geometry of the optical assembly itself is unchanged. Such an approach may cause user-confusion and/or user-error. The additional surfaces, user-defined calculations, and optimization constraints also make optimization and modeling less computationally efficient.

For example, to model changes in the relative positions of the elements due to a change in temperature, three additional fiducial surfaces are added for each seat contact (depicted with vertical dashed lines). For a seat on a front surface, a fiducial surface is added at the seat location followed by the two lens element surfaces, followed by fiducial surfaces at the front surface vertex and another at the seat location (but “after” the lens surfaces). For a seat on a rear surface, fiducial surfaces are added at the seat location and the rear surface vertex, followed by the two lens element surfaces, then another fiducial surface at the seat location (but “after” the lens surfaces). User-defined calculations are then used to determine how the spacings between these surfaces (and other parameters) change with temperature.

Optimization constraints may ensure that the parameters locating the seat relative to the element remain correct even if the nominal optical system parameters change via optimization. The number of additional surfaces used to model thermal expansion exceeds the number of surfaces involved in the original specification.

The method described above has additional challenges. First, because optimization constraints are used to ensure the specification of the optical system remains accurate if lens parameters are changed, it does not support changes to lens parameters outside of optimization (unless the user re-runs the feature). Second, the method does not support more complicated housing embodiments that link non-consecutive elements with different materials. That is, this feature can be used to connect element 1 to element 2 with steel and element 2 to element 3 with brass, but it does not support connecting element 1 to element 3 with steel and element 2 to element 3 with brass. Such more general seat-based housings are discussed further below. Just as the approach described above only works for spacer-based housings, an approach designed specifically for seat-based housings (or those equivalent) has similar challenges. In particular, the distance between two optical elements will only depend on the change in temperature, the material properties of the housing element separating those optical elements, the materials of those elements, and the sizes and shapes of the optical element surfaces contacting the seats.

Modeling and optimizing optical system having more complex housings is significantly more complex. Existing modeling systems do not manage this increased complexity in a tractable way, instead imposing that burden onto the specification of the optical assembly and therefore the user. Improved modeling systems are needed to manage this complexity. A modeling system as disclosed herein manages this complexity.

Although a determined user might extend the functionality of a modeling system designed specifically for spacer-based housings or relatively low-complexity seat-based housings to handle more complicated housings via the addition of user-specified fiducial surfaces and user-defined constraints, as the complexity of the housing grows, the difficulty of determining how to add these fiducial surfaces and user-defined constraints also grows. Such an approach is tedious, error-prone, and consequently impractical for use with general housings.

As noted further above, there are multiple ways for specifying positions of optical elements of an optical assembly. When the optical assembly is realized in fabrication, the positions of the optical elements are determined by their mounting onto the housing. Thus, it is useful to ensure that the positions of the optical elements as determined by the housing elements are consistent with the specification of the nominal optical assembly.

One approach to this challenge is to modify the way the nominal optical assembly is specified to include the specification of the lengths of the housing elements. For example, the method described further above for simple seat-based housings takes such an approach, in that the distances between the mechanical fiducial surfaces that locate seats relative to each other correspond to the lengths of the housing elements. One downside to this approach is that it modifies the way the nominal optical assembly is specified, which can be a source of user error and confusion.

Another approach is to determine those details from the specification of the nominal optical assembly. A limited example of this approach is described further above with respect to spacer-based housings, wherein lengths of spacers are determined based on the distance between neighboring lens elements and the radial points of contact of the spacers with those optical elements.

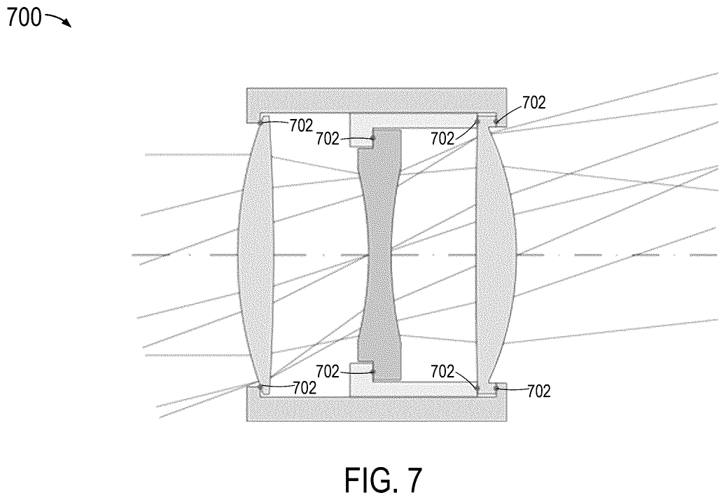

Examples presented above are directed to relatively simple spacer-based and simple seat-based housings. In practice, optical systems may be built using housings that are more complex than the spacer-based and simple seat-based housings described above. FIG. 7 depicts an optical system 700, according to an embodiment. Optical system 700 includes a triplet with a seat-based housing that goes beyond a simple seat-based housing. Optical system 700 may not necessarily represent a practical housing, but it illustrates a variety of salient features of such housings, including:
Each optical element contacts the housing on one surface, at its seat.
An optical element may have more than one seat.
As with the simple seat-based housing, the optical elements are made to contact the housing. This contact can be the result of an adhesive or because the elements are pushed against the housing with a retaining ring or a spring-like mechanism. Points of contact between optical elements and housing elements are denoted 702.
As with the simple seat-based housing, the optical elements can be attached to the housing directly on a curved surface (e.g., as shown for the first optical element in FIG. 7), or on a flat that is cut into the surface (e.g., as shown for the second optical element), on a flat that extends from the surface (e.g., as shown for the third element), or on the edge.
As with the simple seat-based housing, the housing can be comprised of different materials (as shown in FIG. 7), or it can be monolithic.
The same housing material need not contact adjacent optical elements; it can skip over one or more elements (e.g., one housing material shown in FIG. 7 contacts the first and third optical elements, and a second material contacts the second and third elements).

Given the lens model for some nominal temperature and the location where the housing seats contact the optical elements, the length of the housing between each seat can be determined for the nominal temperature. This is needed to determine how elements move with respect to each other when the temperature changes.

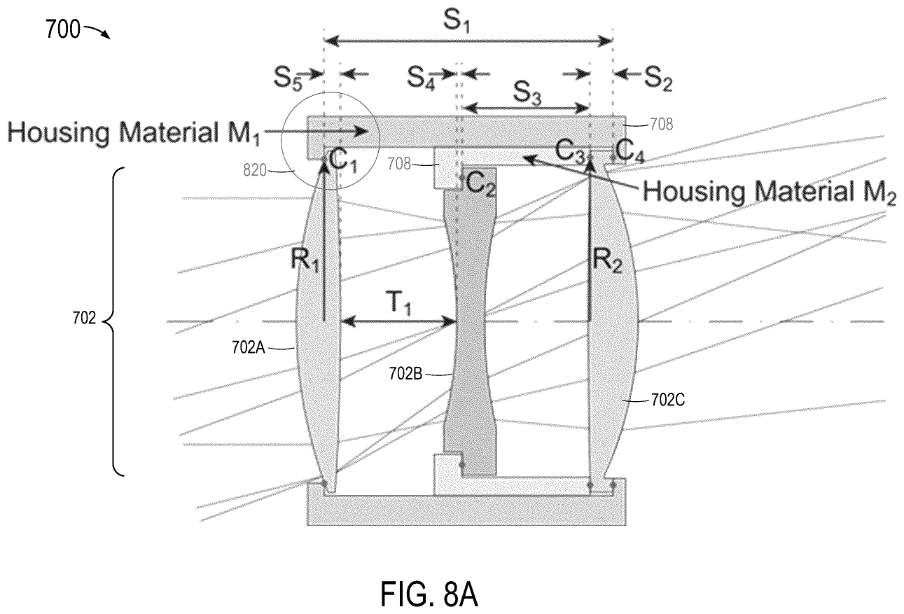

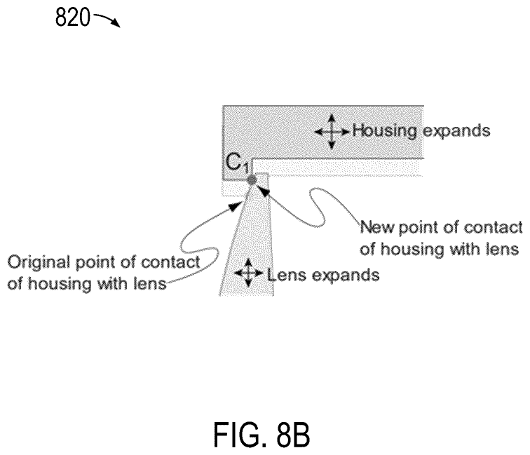

A modeling system as disclosed herein essentially infers details of a general housing (e.g., a variety of types of optical system housings) based on a nominal specification of the associated optical assembly. An advantage of this approach is that it avoids modifying the way the nominal system was specified, avoiding the potential areas of user error and confusion. To infer the details of the housing, the modeling system may determine which parameters of the general housing specification and nominal optical assembly are to be used to calculate the changes in positions of optical elements in the assembly. If restricted to spacer-based housings, this problem is trivial: as noted above, in that case, the distance between two optical elements will only depend on the nominal length of the spacer, the change in temperature, the material properties of the spacer separating those elements, the materials of those elements, and the shapes of the surfaces contacted by the spacer. In contrast, determining which parameters are involved in these calculations for general housings is more complicated. Examples are provided below with reference to FIGS. 8A and 8B. FIG. 8A depicts optical system 700, according to an embodiment. FIG. 8A further includes variables for modeling a change in relative position between optical elements 1 and 2 of optical system 700. FIG. 8B depicts a region 820 of optical system 700, according to an embodiment.

For general housing configurations, calculating how optical element positions change with respect to each other as the system changes temperature is complex. For example, consider calculating how the distance between the first and second elements changes with temperature (e.g., T1 in FIG. 8A). The variables needed for this calculation are shown in FIG. 8A.

T1 may be computed as follows:
1. The expansion of the first element is determined for the new temperature.
2. The expansion of the housing with material M1 is determined for the new temperature, such as depicted in FIG. 8B.
3. Based on the results of steps 1 and 2, the new contact point of the housing with the first element (C1) is determined by (3i) shifting the point of contact transversely according to the expansion of the housing material M1 and (3ii) shifting the lens (after expansion) longitudinally so that it contacts the housing at the point computed at step (3i).
4. Based on step 2, the new value for S1 is determined for the new temperature.
5. The expansion of the third element is determined.
6. Based on step 2 and step 5, the new point of contact of the housing M1 with the third element (C4) is determined.
7. The expansion of the housing material M2 is determined.
8. Based on step 5 and 6, the new contact point of the housing M2 with the third element (C3) is determined.
9. Based on steps 4 and 5, the new value for S2 is determined.
10. Based on step 6, the new value for S3 is determined.
11. The expansion of the second element is determined.
12. Based on steps 7 and 11, the new contact point of the housing M2 with the second element (C2) is determined.
13. Based on step 10, the new value for S4 is determined.
14. Based on steps 1 and 3, the new value for S5 is determined.

The new value for T1 is then given by T1=S1−(S2+S3+S4+S5). Note that the change in the point of contact between a housing element and an optical element can be omitted if that point of contact lies on a flat surface.

This is a complicated procedure, even for the simplified example of FIG. 7. For more complicated optical systems, which may include a housing element that spans entire optical assembly instead of just a single element, the procedure may be even more complicated, and may be confusing, impractical, or impossible to do so with user-defined constraints or a conventional modeling system.

Moreover, a specification of an optical assembly may be over-determined or under-determined with respect to housing elements, such that unique solutions for distances like T1 may be indeterminable. In such a situation, a user may be responsible for detecting such over-determined or under-determined conditions in order to model or optimize such an optical assembly over a range of temperatures. In addition, in order to alter features of the housing or the optical assembly, such as to add a housing element or an optical element, or to use a different coordinate system in the specification of the optical assembly, a user may have to re-determine which parameters of the nominal optical assembly and the housing are needed to determine the positions of the optical elements as the housing dimensions change with temperature. In contrast, methods disclosed herein perform these steps for the user, with substantially less user involvement.

Moreover, note that many of the intermediate variables used to calculate T1 are also needed for other thermal expansion calculations. For example, the change in the point of contact with the middle element and the housing is also needed to calculate the change in the relative positions of the second and third elements. It is inefficient to re-calculate these intermediate variables every time they are used.

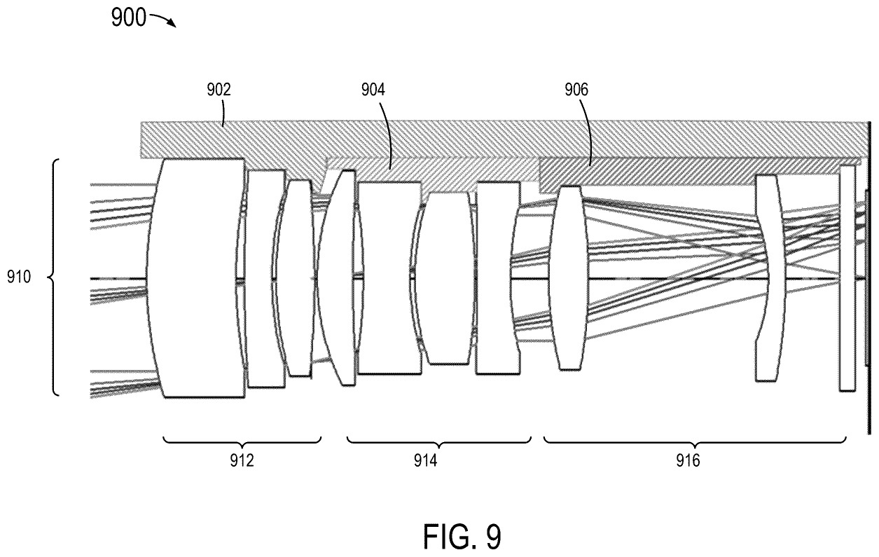

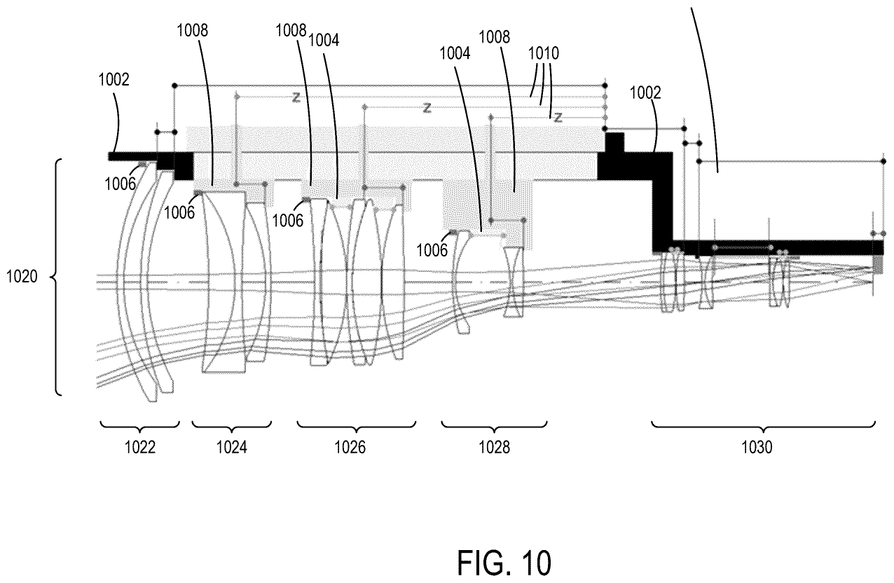

Although the example of FIG. 7 is relatively simple, the procedure to compute T1 is far from trivial. Examples of more realistic housings are presented below with reference to FIGS. 9 and 10 to illustrate how complicated the procedures may become.

FIG. 9 depicts an optical system 900, according to an embodiment. Optical system 900 includes a housing having housing elements 902, 904, and 906, which may be made of different materials. Optical system 900 further includes an optical assembly 910 that includes ten optical elements. Optical elements 912 are seated in housing element 902. Optical elements 912 are also connected to the image plane. The housing thus does not fall into the category of a simple seat-based housing. Optical elements 914 are seated in housing element 904, which sits within and abuts housing element 902. Optical elements 916 are seated in housing element 906, which sits within housing element 902 and abuts housing element 904. In the example of FIG. 9, when an environmental conditional changes (e.g., when the temperature increases), housing element 904 may expand to the right, which in turn will push housing element 906 to the right.

In the example of FIG. 9, housing element 902 contacts seats of optical elements 912, housing element 904, and the image plane. Housing element 904 contacts the optical elements 914, and housing elements 902 and 906. Housing element 906 contacts the optical elements 916 and housing element 904. The example of FIG. 9 thus exceeds the restrictions of the simple seat-based approach described further above.

FIG. 10 depicts an optical system 1000, according to an embodiment. Optical system includes external housing elements 1002, spacers 1004, structures 1006 that retain optical elements in contact with the spacers or seats, subassembly cells 1008 that connect to the external housing via components 1010. Components 1010 that are denoted with a “Z” indicate that they can “zoom” or control subassembly cells 1008 to move relative to one another. In this example, optical system 1000 may be referred to as a zooming optical system. Optical system 1000 further includes an optical assembly 1020 that includes multiple groups of optical elements, depicted here as groups 1022, 1024, 1026, 1028, and 1030. In the example of FIG. 10, groups 1024, 1026, and 1028 are held by subassembly cells 1008, which may move to change the focal length of optical assembly 1020 maintaining the location of the image plane. Groups 1024, 1026, and 1028 may move in a mechanical cam, or may be controlled electronically by a lead screw. In FIG. 10, optical elements of group 1022 are held in a seat-based housing. Optical elements of groups 1026 and 1028 are held in spacer-based housings. Groups 1022 and 1030 include stationary optical elements, which may be retained with a seat-based and/or spacer-based housing elements.

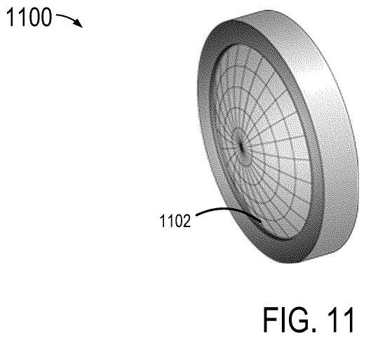

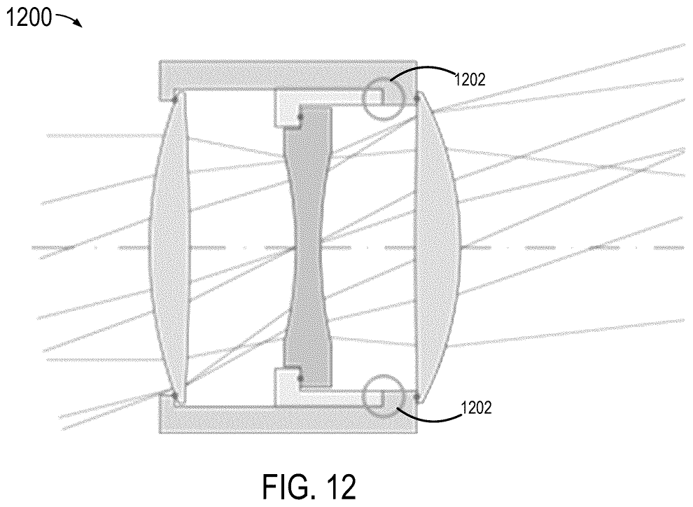

An optical assembly may be modeled based on a specification for a nominal environmental condition, parameters of the environmental condition (e.g., a nominal or ambient temperature), and additional information described below.
1. Information regarding locations at which seats contact optical elements.
   a. Includes whether the contact is on the optical surface, on an edge flat (i.e., flat bevel), on a flange or notch offset from the surface, or on the edge of the optical element.
   b. For rotationally symmetric systems, the location may be specified as a radial distance from an axis (e.g., a seat may contact an optical element along a circle over a surface of the optical element, such as depicted with a circle 1102 of an optical element 1100 in FIG. 11).
   c. For non-rotationally symmetric systems, the location may include multiple points of contact (e.g., for hexapod structures). For rotationally symmetric systems, the optical elements may have a finite set of points of contact with the housing (e.g., 3 points of contact). Such an arrangement may behave the same as for the case of (1.b.) above provided that the points of contact occur at the same radial distance from the axis.
2. Which seats are connected to each other and the housing material used to make these connections.
3. Whether any housing elements with different materials contact each other, and if so, the locations of these points of contact (an example of this is illustrated in circled regions 1202 of housing elements of an optical system 1200 depicted in FIG. 12).
4. Operating temperatures for the optical and housing elements at which they wish to analyze/optimize the system. The temperature need not be the same for each optical or housing element. For example, where the optical system operates in the infra-red, a subset of optical elements and/or housing elements may be cooled (e.g., located within a dewar that is cooled by liquid nitrogen).
5. If the material of a space between optical elements is air, the space may be treated as a fluid that does not add stress to an optical element as the optical element expands. Other materials (e.g., water) may also be treated as a such a fluid. A user or specification may indicate such fluid spaces so that they are not treated as cemented elements.

A modeling system, as disclosed herein, may determine whether a specification over-determines locations of one or more optical elements as the environmental condition changes. An over-determined specification may represent an input error. In the event of over-determined specification, the modeling system may ignore some portion of the specification and/or may prompt a user to modify the specification.

The modeling system may determine whether the specification under-determines locations of one or more of the optical as the environmental condition changes. An under-determined specification may arise where a designer intends for one or more of the optical elements to be actively controlled (e.g., to compensate for a change in the environmental condition). In such a situation, the modelling system may not automatically modify the thickness of one or more air/fluid spaces based on a change in the environmental condition. The modeling system may determine that the housing specification is well-determined, and may proceed to uniquely determine locations of optical elements for one or more environmental conditions.

The modeling system may determine sizes, locations, surface profiles, and refractive indices of the optical elements for specified environmental conditions. The modeling system may provide the locations in the fashion in which the nominal system was specified (e.g., the location of a surface of an optical element may be specified by a thickness from a preceding surface of an optical element).

The modeling system may permit, support, and/or integrate any analysis that can be performed on the nominal system for one or more of the environmental conditions.

The modeling system may allow optimization of the optical assembly taking into account the performance at one or more of the environmental conditions, including a nominal environmental condition.

The modeling system may not require modifications to the optimization settings beyond those used to optimize the nominal optical assembly.

The modeling system may perform as described further above for general housings. Specific housing types described further above (e.g., spacer-based and simple seat-based) are a subset of general housings, so the modeling system will perform as described for such housings.

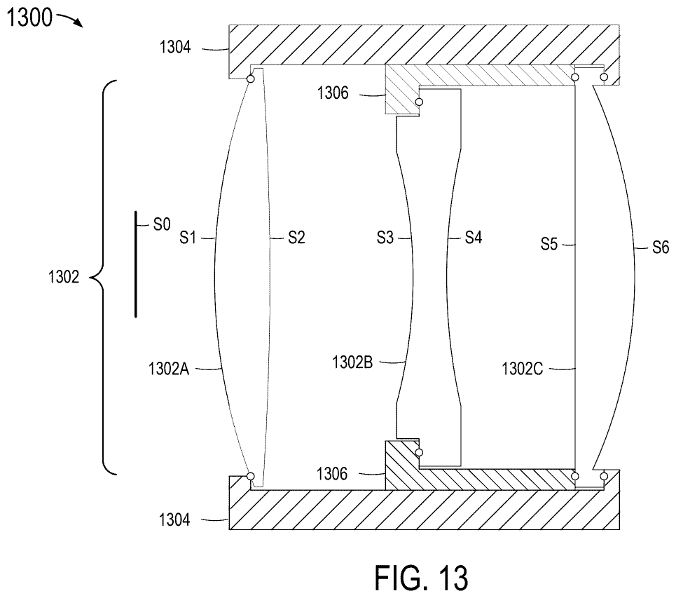

Example modeling systems and methods for modeling an optical assembly for one or more environmental conditions are provided below. FIG. 13 depicts an optical system 1300 that includes an optical assembly 1302 and housing elements 1304 and 1306, according to an embodiment. Optical assembly 1302 includes an optical element 1302A having surfaces S1 and S2, an optical element 1302B having surfaces S3 and S4, and an optical element 1302C having surfaces S5 and S6. A surface S0 may represent a reference surface. The reference surface may be a surface of another optical element and/or a light source.

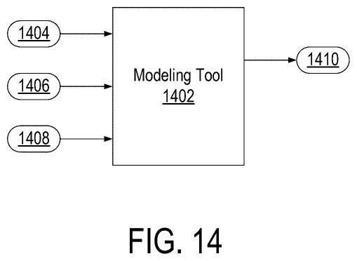

FIG. 14 depicts a modeling system 1402 that models optical assemblies, according to an embodiment. Modeling system 1400 may include circuitry that performs various functions disclosed herein. The circuitry may be combined or distributed in one or more of a variety of combinations, without deviating from the scope of the present disclosure. Alternatively, or additionally, the system may include a processor and memory configured with instructions/code to perform one or more of the functions disclosed herein. Modeling system 1400 may represent a centralized system and/or a distributed system.

Modeling system 1402 may model an optical assembly based on a specification 1404 of the optical assembly, housing information 1406, and environmental parameters 1408. Housing information 1406 may include locations at which optical elements of the optical assembly contact housing elements, types of materials of the contacted housing elements, and properties of the materials. Environmental parameters 1408 may include parameters of a nominal/ambient environmental condition, and may further include parameters of one or more additional environmental conditions. Modeling system 1402 may output parameters 1410 (e.g., locations/positions) of optical elements of the optical assembly, for one or more environmental conditions.

In the description that follows, terms like “graph”, “sub-graph”, “edge” and so on are in the context of graph theory. In computer science, graph theory is the study of graphs, which are mathematical structures used to model pairwise relations between objects. A graph in this context is made up of vertices (also called nodes or points) which are connected by edges (also called arcs, links or lines).

In an example, modeling system 1402 represents an optical assembly as one or more graphs in which nodes represent surfaces of optical elements, and edges (i.e., connections amongst nodes), represent relationships amongst the surfaces. Modeling system 1402 may convert specification 1404 of the optical assembly to the one or more graphs. Modeling system 1402 may represent the optical assembly as one or more directed acyclic graphs (DAGs). Examples are provided below for a situation in which modeling system 1402 models optical assembly 1302. In the following examples, specification 1404 provides the location/position of surface S1 relative to a surface S0 (e.g., a light source or illuminated object), the location/position of surface S2 relative to surface S1, the location/position of surface S3 relative to surface S2, the location/position of surface S4 relative to surface S3, the location/position of surface S5 relative to surface S4, and the location/position of surface S6 relative to surface S5. Modeling system 1402 is not, however, limited to the foregoing sequential location/position referencing method.

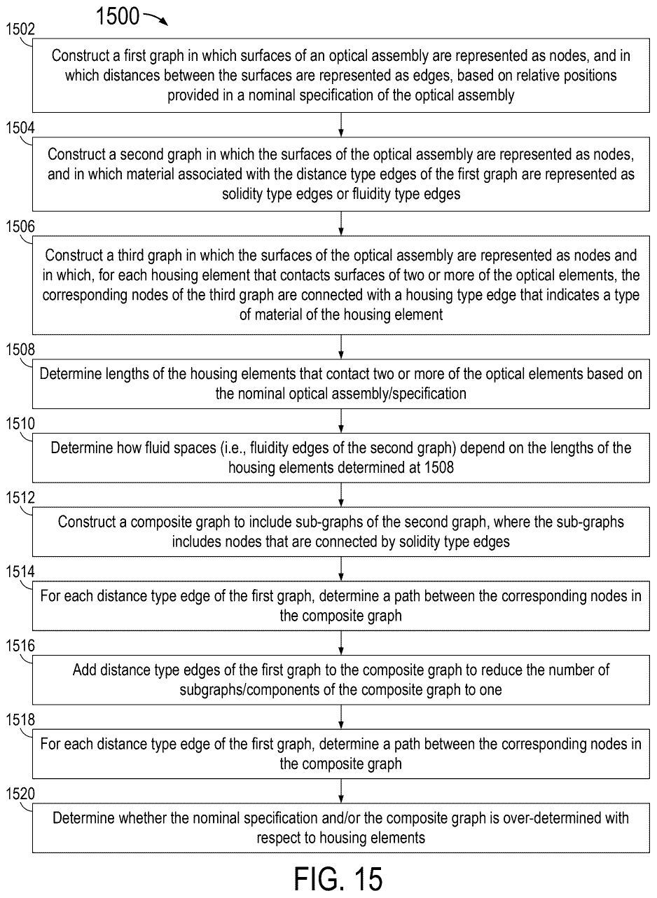

FIG. 15 depicts a method 1500 of constructing a model of an optical assembly and using the model to determine parameters of the optical assembly under one or more environmental conditions, according to an embodiment. Method 1500 is described below with reference to FIGS. 13, 14, and 16 through 30.

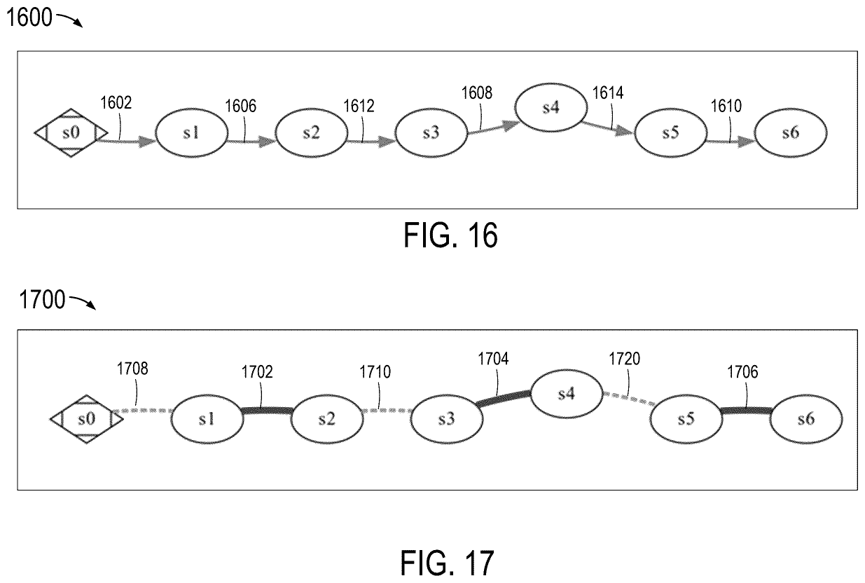

At 1502, modeling system 1402 constructs a first graph (i.e., a distance graph or coordinate system graph) in which surfaces S0 through S6 of optical assembly 1302 are represented as nodes, and in which distances provided in specification 1404 are represented as edges, such as depicted in a graph 1600 of FIG. 16. In a rotationally symmetric optical assembly or subassembly, the coordinate system of one surface relative to the previous surface can be specified as simply a distance along the shared axis of symmetry from the previous surface. Graph 1600 represents the way the user has specified the positions of the optical elements. Graph 1600 shows how the surfaces'coordinate systems are referenced to each other (e.g., surface S1 is specified relative to surface S0, and a corresponding distance type edge 1602 points from surface S0 to surface S1). Distance type edges 1606, 1608, and 1610 represent thicknesses of respective optical elements 1302A, 1302B, and 1302C. Distance type edge 1612 represents a distance between surfaces S2 and S3 of optical elements 1302A and 1302B, respectively. Distance type edge 1614 represents a distance between surfaces S4 and S5 of optical elements 1302B and 1302C, respectively. In terms of graph theory, this forms a directed linear graph (or a directed path graph). Modeling system 1402 is not limited to the example of FIG. 16, and may support other (e.g., multiple) reference methods. Modeling system 1402 may, for example, support specifications that use a global coordinate system, a single reference point for multiple optical elements, and/or a tree type structure (e.g., a connected graph with no cycles). In other words, a user may specify an optical assembly in one or more of ways, including any manner of coordinate systems and associated parameters, and modeling system 1402 will determine changes to those parameters based on the specification, environmental conditions, and properties of materials of housing elements.

At 1504, modeling system 1402 constructs a second graph (i.e., a solidity graph) in which surfaces S0 through S6 of optical assembly 1302 are represented as nodes, and in which material associated with the distance type edges of graph 1600 are represented as solidity type edges or fluidity type edges, such as depicted in a graph 1700 of FIG. 17. In FIG. 17, solidity type edges 1702, 1704, and 1706 represent solid materials of the respective optical elements (e.g., optical glass and/or plastic). Fluidity type edges 1708, 1710, and 1712 represent “fluid” material (e.g., air, nitrogen, and/or water) between the optical elements.

The second graph describes the “solidity” or “fluidity” of the material between two consecutive surfaces. This is a binary choice: the material is either solid or fluid. In the full description of an optical assembly (e.g., specification 1404), many different solid materials and many different fluid materials may be used in any combination, but for the purposes of the second graph, only solidity or fluidity is important. The second graph describes sets of surfaces that are connected to form a single solid, that is, the “optical elements.”

The first two graphs represent information specified in (or properties readily derivable from) a specification of an optical assembly.

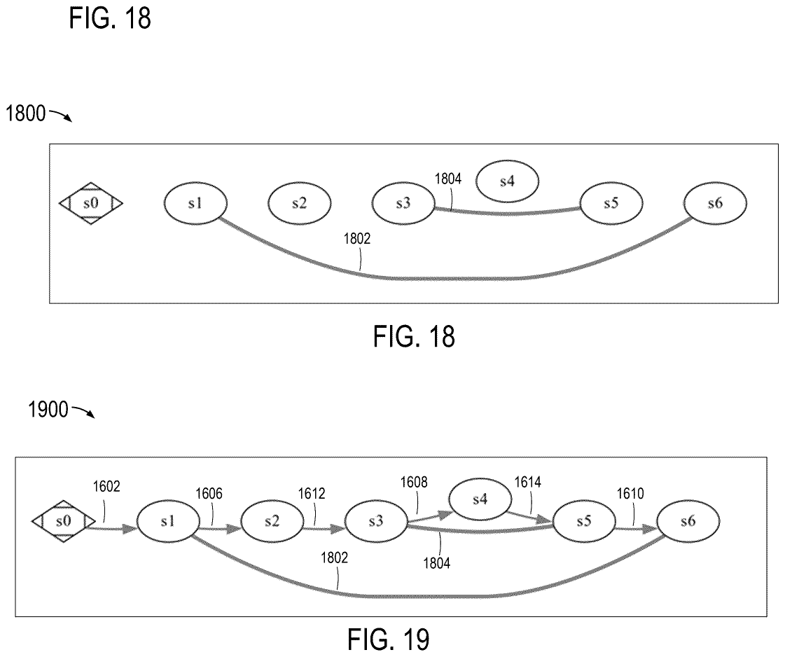

At 1506, modeling system 1402 constructs a third graph (i.e., a housing graph) in which surfaces S0 through S6 of optical assembly 1302 are represented as nodes and in which, for each housing element that contacts surfaces of two or more (e.g., a pair) of the optical elements, the corresponding nodes of the third graph are connected with a housing type edge that indicates the type of material of the housing element, such as depicted in a graph 1800 of FIG. 18.

In FIG. 18, a housing type edge 1802 represents housing element 1304, between points of contact with surface S1 of optical element 1302A and surface S6 of optical element 1302C. A housing type edge 1804 represents housing element 1306, between points of contact of surface S3 of optical element 1302B and surface S5 of optical element 1302C.

As with the second graph (e.g., solidity graph 1700), specific materials of housing elements 1304 and 1306 are not represented in housing graph 1800. Rather, housing type edges 1802 and 1804 represent whether a housing element contacts surfaces of multiple optical elements. Housing edges of the third graph influence performance of the optical assembly across environmental conditions in that different housing edges produce different optical performance of the optical assembly when modeled across a given range of environmental conditions.

At 1508, modeling system 1402 determines lengths of housing elements (e.g., housing elements that contact two or more optical elements) based on the nominal optical assembly (e.g., specification 1404). Modeling system 1402 may derive the length of each housing element based on the spacing of the surfaces as specified in the nominal optical assembly (e.g., specification 1404) given by the first graph (e.g., coordinate system graph 1600) and by the housing type edges of the third graph (e.g., housing graph 1800). For each housing edge in the third graph, modeling system 1402 may determine a path (i.e., a list of edges) between the surfaces of the first subgraph, such as depicted in a graph 1900 of FIG. 19. In FIG. 19, for housing type edge 1802, distance type edges 1606, 1612, 1608, 1614, and 1610 provide a path between corresponding nodes of surfaces S1 and S6. For housing type edge 1804, distance type edges 1608 and 1614 provide a path between corresponding nodes of surfaces S3 and S5. The lengths of the housing elements represented by housing type edges 1802 and 1804 depend on the sum of the displacements between the surfaces in the associated path of distance type edges as well as the surface shape function of the surfaces being connected. Modeling system 1402 may determine the displacement between surfaces S1 and S6, for the nominal environmental condition, based on information/parameters contained within and/or associated with distance type edges 1606, 1612, 1608, 1614, and 1601, and housing type edge 1802. Modeling system 1402 may determine the displacement between surfaces S3 and S5, for the nominal environmental condition, based on information/parameters contained within and/or associated with distance type edges 1608 and 1614, and housing type edge 1804. Modeling system 1402 may also determine changes in the displacements for one or more other environmental conditions based on one or more isometric thermal expansion methods.

At 1510, modeling system 1402 determines how fluid spaces (e.g., fluidity type edges 1708, 1710, and 1720 in solidity graph 1700), depend on the lengths of the housing elements determined at 1508.

To model the nominal optical assembly at other temperatures, modeling system 1402 may determine how the parameters represented by the distance type edges of the first graph change as the environment condition changes. Modeling system 1402 may determine a path for each distance type edge through a composite graph composed of the first, second, and third. Modeling system 1402 may compose the composite graph as described below.

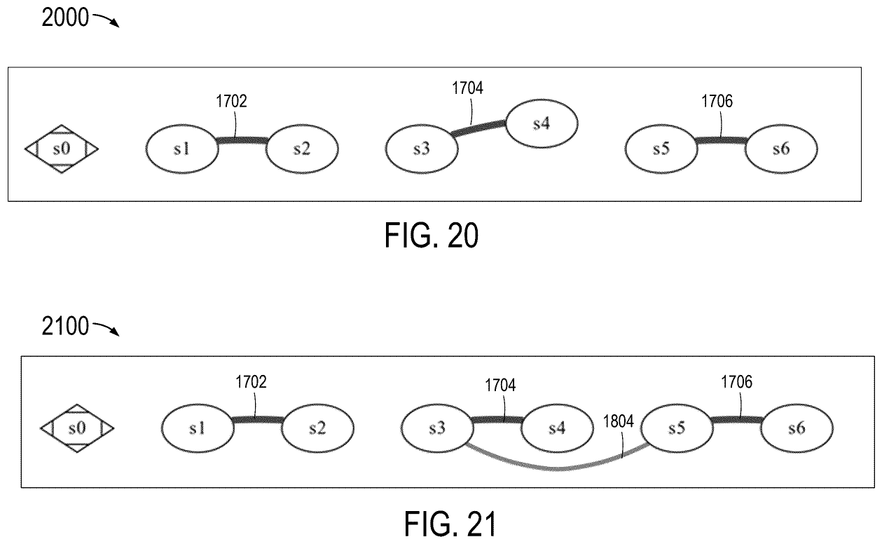

At 1512, modeling system 1402 composes the composite graph to include sub-graphs of the second graph, where the sub-graphs include nodes that are connected by solidity type edges. Modeling system 1402 may ignore fluidity type edges. In the example of FIG. 17, modeling system 1402 may compose the composite graph to include subgraphs formed by solidity type edges 1702, 1704, and 1706, such as depicted in FIG. 20. In the example of FIG. 20, there are four sub-graphs or components. The first subgraph includes node S0. The second subgraph includes nodes S1 and S2. The third subgraph includes nodes S3 and S4. The fourth subgraph includes nodes S5 and S6.

The next task is to connect the subgraphs using the housing type edges. At 1514, modeling system 1402 composes the composite graph to further include housing type edges of the third graph that connect two or more of the sub-graphs of FIG. 20. Modeling system 1402 may add a housing type edge to the composite graph if the housing type edge reduces the number of subgraphs/components in the composite graph. Modeling system 1402 may consider each housing type edge. The order in which modeling system 1402 considers/adds housing type edges is an arbitrary choice, and does not change the result unless a subgraph is over-determined, such as discussed further below.

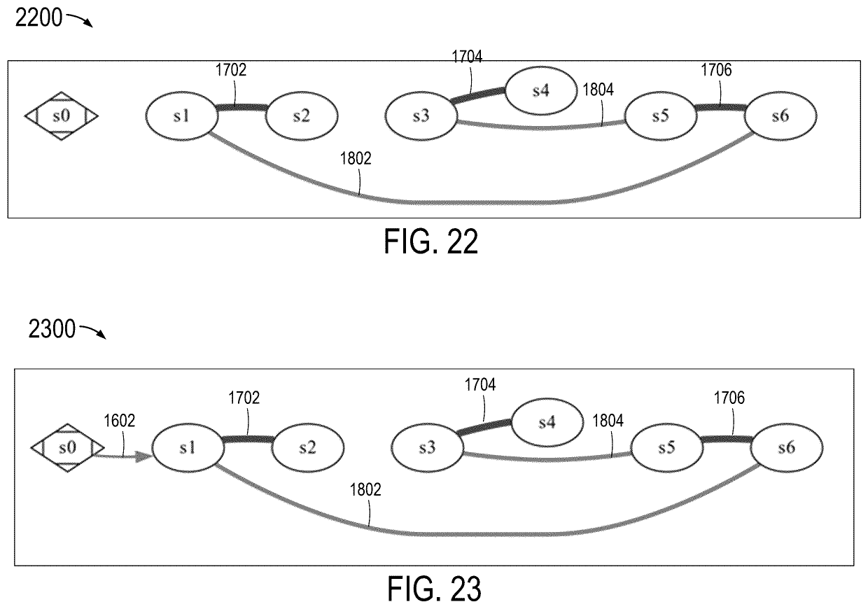

In FIG. 21, housing type edge 1804 reduces the number of subgraphs/components from four to three. In FIG. 22, housing type edge 1802 reduces the number of subgraphs/components from three to two. When all of the housing type edges of graph 1800 have been considered, processing proceeds to 1516.

At 1516, modeling system 1402 adds distance type edges of the first graph to the composite graph to reduce the number of subgraphs/components of the composite graph to one. Modeling system 1402 may consider the distance type edges sequentially, based on the directions of the distance type edges (e.g., beginning with distance type edge 1602 in FIG. 16), but this is an arbitrary choice and modeling system 1402 may order the distance type edges based on other ordering criteria. Different ordering criteria may result in different free parameters (parameters whose value the user can freely choose), but impacts due to changes in environmental conditions will be the same.

In composite graph 2300 of FIG. 23, distance type edge 1602 reduces the number of subgraphs/components from two to one. Composite graph 2300 illustrates how surfaces S0 through S6 are connected relative to one another. Distance type edges of the composite graph (e.g., distance type edge 1602 of composite graph 2300) represent coordinate system parameters that a user may change (i.e., free parameters). Solidity type edges (e.g., solidity type edges 1702, 1704, and 1706 in composite graph 2300) represent solid elements (e.g., solid optical elements), and housing edges (e.g., housing type edges 1802 and 1804 in composite graph 2300) represent housing elements.

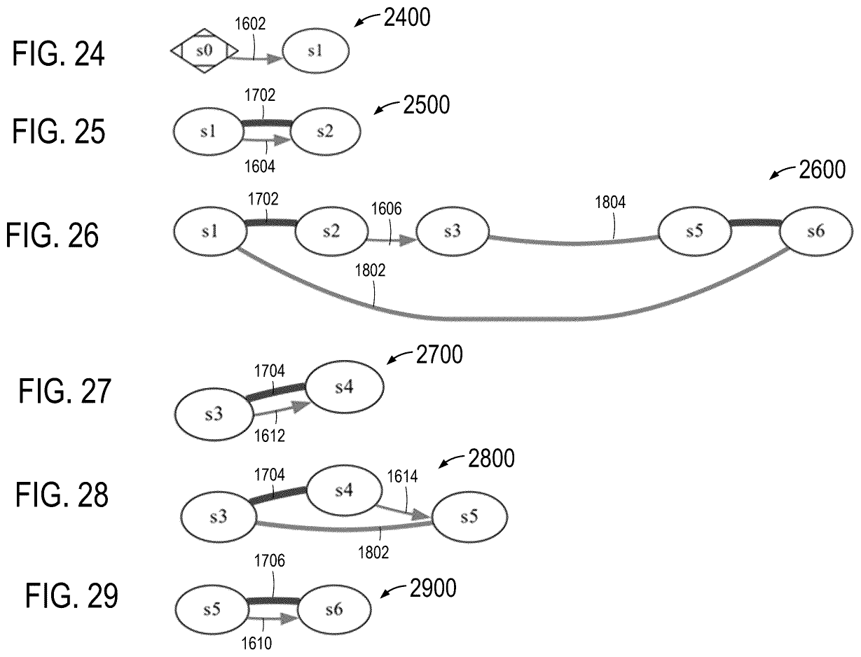

At 1518, for each distance type edge of the first graph (e.g., coordinate system graph 1600), modeling system 1402 determines a path between the corresponding nodes in the composite graph, such as depicted in FIGS. 24 through 29.

FIG. 24 depicts a subgraph 2400 of distance type edge 1602, according to an embodiment. FIG. 25 depicts a subgraph 2500 of distance type edge 1604, according to an embodiment. FIG. 26 depicts a subgraph 2600 of distance type edge 1606, according to an embodiment. FIG. 27 depicts a subgraph 2700 of distance type edge 1606, according to an embodiment. FIG. 28 depicts a subgraph 2800 of distance type edge 1608, according to an embodiment. FIG. 29 depicts a subgraph 2900 of distance type edge 1610, according to an embodiment.

In FIGS. 24 through 29, edge types determine how the relative positions of the corresponding surfaces are to be determined for environmental conditions. Conveniently, this process does not rely on any specific coordinate system graph: the process is valid for other coordinate systems, including global coordinate systems in which each surface is specified relative to any other surface in the optical assembly.

The structure of the coordinate system graph represents the parameters with which the user has chosen to specify the nominal optical assembly, and modeling system 1402 determines how to calculate those parameters under other environmental conditions. The user does not need to change how the optical assembly is specified.

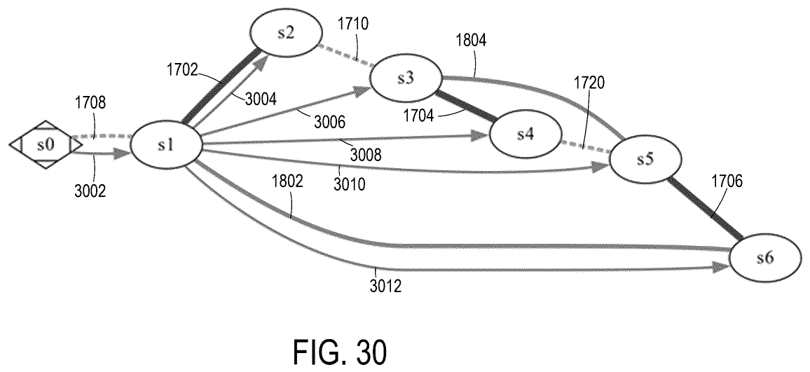

FIG. 30 depicts a composite graph 3000 for an example in which optical assembly 1302 is specified using the coordinate system of FIG. 2, according to an embodiment. In FIG. 30, the structures of housing type edges 1802 and 1804 and the solidity type edges are the same as in composite graph 2300. The structures of distance type edges 3002 through 3012 differ from that of distance type edges of FIG. 16, in that the distance type edges of graph 3000 do not form a linear graph.

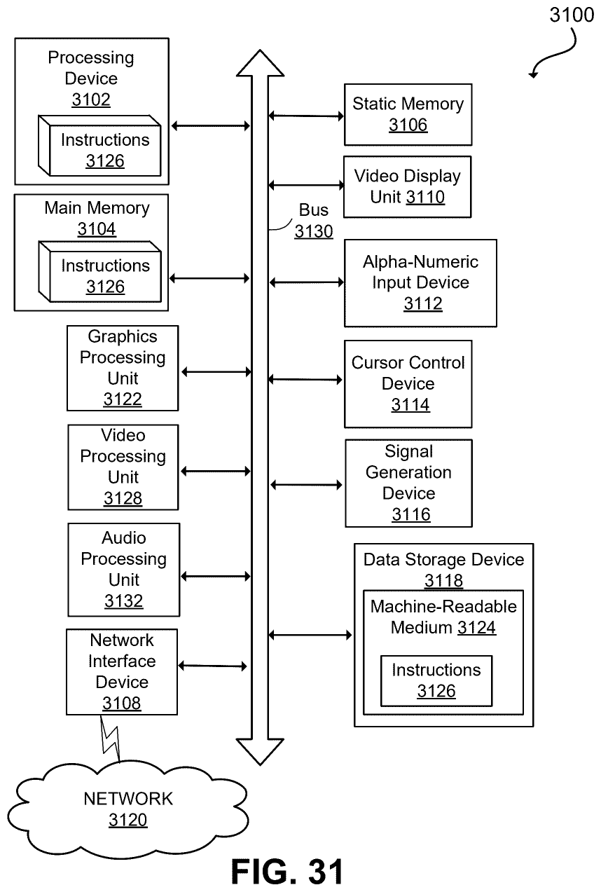

At 1520, modeling system 1402 may determine whether specification 1404 is over-determined with respect to housing elements. Modeling system 1402 may determine that an over-determined condition exists if a housing type edge would result in a cycle if added to the composite graph. In such a situation, a physical model of thermal expansion is over-determined, and thermal changes to the nominal optical assembly cannot be computed until one or more housing edges are removed or ignored. Modeling system 1402 may automatically remove or ignore such a housing type edge, and/or may prompt a user to act. Returning to 1514, if a housing type edge does not reduce the number of components in the composite graph, adding the housing type edge to the composite graph would result in an over-determined model. Another example includes simultaneously modeling an optical subassembly for multiple environmental conditions, characterized by having one nominal environment, in which the defining parameters of the system (radii, thicknesses, spaces, refractive indices, etc.) may be freely varied by the user or by an optimization routine, and one or more differing environmental conditions in which most if not all of the parameters in the system specification are not freely variable but are determined by the corresponding values of the specification for the optical subassembly at the nominal environmental condition, and the differences in pressure and temperature from the nominal, characterized by the fact that the various optical elements of the system are connected to each other via a housing, which may be of multiple materials, in which these connections between the elements do not connect only adjacent surfaces or elements but may connect at least two non-adjacent surfaces, and further characterized by the fact that it is not necessary to modify the specification of the optical subassembly for the nominal environmental condition (e.g., by adding fiducial reference surfaces) in order to facilitate the modeling of the optical subassembly at the differing environmental conditions. FIG. 31 illustrates an example machine of a computer system 3100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 3100 includes a processing device 3102, a main memory 3104 (e.g., read-only memory (ROM), flash memory, dynamic random access memory (DRAM) such as synchronous DRAM (SDRAM), a static memory 3106 (e.g., flash memory, static random access memory (SRAM), etc.), and a data storage device 3118, which communicate with each other via a bus 3130.

Processing device 3102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 3102 may also be one or more special-purpose processing devices such as an application specific integrated circuit (ASIC), a field programmable gate array (FPGA), a digital signal processor (DSP), network processor, or the like. The processing device 3102 may be configured to execute instructions 3126 for performing the operations and steps described herein.

The computer system 3100 may further include a network interface device 3108 to communicate over the network 3120. The computer system 3100 also may include a video display unit 3110 (e.g., a liquid crystal display (LCD) or a cathode ray tube (CRT)), an alphanumeric input device 3112 (e.g., a keyboard), a cursor control device 3114 (e.g., a mouse), a graphics processing unit 3122, a signal generation device 3116 (e.g., a speaker), graphics processing unit 3122, video processing unit 3128, and audio processing unit 3132.

The data storage device 3118 may include a machine-readable storage medium 3124 (also known as a non-transitory computer-readable medium) on which is stored one or more sets of instructions 3126 or software embodying any one or more of the methodologies or functions described herein. The instructions 3126 may also reside, completely or at least partially, within the main memory 3104 and/or within the processing device 3102 during execution thereof by the computer system 3100, the main memory 3104 and the processing device 3102 also constituting machine-readable storage media.

In some implementations, the instructions 3126 include instructions to implement functionality corresponding to the present disclosure. While the machine-readable storage medium 3124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 3102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer-implemented method for modeling an optical assembly across multiple environmental conditions, comprising:
retrieving a specification in electronic format of an optical assembly for one or more environmental conditions among the multiple environmental conditions, the specification being devoid of at least some optical system information of the optical assembly for at least one of the multiple environmental conditions; and
constructing a computer model of the optical assembly based on the specification, the computer model operative for the multiple environmental conditions, wherein the computer model computes the optical system information for the multiple environmental conditions from the specification.

2. The method of claim 1, wherein constructing the computer model comprises:
computer modelling surfaces of optical elements of the optical assembly as respective nodes of a first graph and, for each node of the first graph, representing a distance between the corresponding surface and a reference surface as a distance type edge between the corresponding nodes of the first graph;
computer modelling the surfaces of the optical elements as nodes of a second graph and, for each distance type edge of the first graph that connects nodes corresponding to first and second surfaces of an optical element, connecting the corresponding nodes of the second graph with a solidity type edge; and
computer modelling the surfaces of the optical elements as nodes of a third graph and, for each housing element that contacts surfaces of two or more of the optical elements, connecting the corresponding nodes of the third graph with a housing type edge that indicates the type of material of the housing element.

3. The method of claim 2, wherein, for each housing type edge of the third graph, constructing the computer model further comprises:
identifying a path between the corresponding nodes in the first graph; and
determining a distance between the corresponding surfaces of the optical element based on the distance type edges of the identified path of the first graph.

4. The method of claim 3, wherein constructing the computer model further comprises constructing a composite graph that comprises:
sub-graphs of the second graph, including the solidity type edges;
housing type edges of the third graph that connect multiple sub-graphs of the composite graph; and
distance type edges of the first graph that connect multiple sub-graphs of the composite graph that are not connected with a housing type edge.

5. The method of claim 4, wherein constructing the computer model further comprises, for each distance type edge of the first graph, determining a composite path between the corresponding nodes in the composite graph.

6. The method of claim 5, further comprising, for each composite path:
determining relative positions of surfaces of the corresponding nodes, for the first environmental condition, based on edges of the composite path; and
determining changes in the relative positions of the surfaces of the corresponding nodes, for a second environmental condition, based on edges of the composite path and the types of materials associated with housing type edges and solidity type edges of the composite path.

7. The method of claim 6, wherein one or more of the first and second environmental conditions comprises differing environmental conditions amongst one or more of:
two or more optical elements;
two or more housing elements: and
an optical element and a housing element.

8. The method of claim 5, wherein constructing the computer model further comprises one or more of:
determining if the model is over-determined based on the composite graph; and
determining if the model is under-determined based on the composite graph.

9. The method of claim 8, wherein constructing the computer model further comprises:
determining that the model is over-determined if one or more of the housing edges of the composite graph result in a cycle in the composite graph.

10. The method of claim 8, wherein constructing the computer model further comprises:
determining that the model is under-determined if the composite graph includes multiple sub-graphs.

11. The method of claim 2, wherein constructing the computer model further comprises:
constructing the model independent of a type of a housing of the housing elements and independent of dimensions of the housing elements.

12. The method of claim 1, wherein the specification lacks dimensions of housing elements of the optical assembly for the at least one of the multiple environmental conditions.

13. The method of claim 1, wherein the specification comprises:
positions of surfaces of optical elements of the optical assembly;
dimensions of the optical elements;
locations at which the surfaces of the optical elements contact housing elements of the optical assembly;
types of materials of the optical elements; and
types of materials of the housing elements.

14. The method of claim 13, wherein the positions of the surfaces of the optical assembly are specified relative to a selectable one of:
other surfaces of the optical elements; and
a coordinate system.

15. The method of claim 14, wherein the specification lacks dimensions of housing elements of the optical assembly.

16. A computer-implemented method for modeling an optical assembly across multiple environmental conditions, comprising:
retrieving a specification in electronic format of the optical assembly;
constructing a first graph in which surfaces of optical elements are represented as nodes and distances between the surfaces as distance type edges based on the specification of the optical assembly;
constructing a second graph in which the surfaces are represented as nodes and materials between consecutive surfaces are represented as solidity type edges or fluidity type edges;
constructing a third graph in which the surfaces are represented as nodes and housing elements that contact surfaces of multiple optical elements are represented as housing type edges indicating material types of the housing elements;
determining lengths of the housing elements for a nominal environmental condition based on paths between nodes in the first graph and the housing type edges in the third graph; and
determining positions of the optical elements for one or more additional environmental conditions based on the determined lengths and material properties of the housing elements.

17. The computer-implemented method of claim 15, wherein constructing the first graph comprises representing the distances as vertex-to-vertex distances between adjacent surfaces of the optical elements.

18. The computer-implemented method of claim 15, wherein the solidity type edges represent solid materials and the fluidity type edges represent fluid materials between the optical elements.

19. The computer-implemented method of claim 15, further comprising composing a composite graph by combining sub-graphs formed by the solidity type edges with the housing type edges that connect the sub-graphs.

20. A non-transitory computer-readable medium storing instructions that, when executed by a processor, cause the processor to perform operations comprising:
modeling an optical assembly for multiple environmental conditions by constructing multiple graphs of the optical assembly, wherein the graphs include a distance graph representing coordinate system relationships between optical element surfaces, a solidity graph representing material properties between surfaces, and a housing graph representing housing element connections between non-adjacent optical elements;
computing housing element dimensions from an optical assembly specification without requiring explicit housing dimensions in the specification; and
automatically determining optical element positions for varying environmental conditions based on the computed housing element dimensions and thermal expansion properties of housing materials.
